(19) United States
(12) Patent Application Publication
(10) Pub. No.: US 2024/0295755 A1
(43) Pub. Date: Sep. 5, 2024

(54) HETEROCHROMIC LENS HAVING REMOTE-CONTROLLED COLOUR CHANGING

(71) Applicant: INSTITUT MINES TELECOM, PALAISEAU (FR)

(72) Inventors: Jean-Louis DE BOUGRENET DE LA TOCNAYE, GUILERS (FR); Laurent DUPONT, PLOUZANE (FR); Emmanuel DANIEL, LE RELECQ KERHUON (FR); Vincent NOURRIT, BREST (FR); Christian PERSON, LAMPAUL PLOUARZEL (FR)

(21) Appl. No.: 18/282,119

(22) PCT Filed: Mar. 16, 2022
(86) PCT No.: PCT/EP2022/056802

§ 371 Date: Sep. 14, 2023

(30) Foreign Application Priority Data
Mar. 19, 2021 (FR) FR2102785

(51) Int. Cl. G02C 7/10; G02C 7/04

(52) U.S. Cl. CPC G02C 7/101; G02C 7/046

(57) ABSTRACT

A contact lens, e.g., of the scleral type, having user-controllable colour changing. An electro-optical structure including at least one layer of a bistable electro-optical absorbent material, which, under the effect of the application of an electric field, can pass from at least one first stable state to at least one second stable state having different colorimetric absorption properties, and vice versa under the effect of the application of an electric field of opposite polarity. This change in state of the material leading to an alteration to the visible colour of the contact lens. The electro-optical structure extending in an annular region intended to cover the iris at least partially while leaving a central zone clear. An electronic circuit encapsulated in the lens and configured to subject the material to an electric field causing the change in state thereof in response to receiving a corresponding control signal.

### TECHNICAL FIELD

The present invention relates to contact lenses that include or do not include a refractive correction, and more particularly a heterochromic lens with remote-control change of color.

### PRIOR ART

Some people want to be able to change the color of their eyes, whether or not there is a need for optical correction.

For this, there are colored contact lenses, of predefined color.

The drawback with these lenses is that it is not possible to change the color other than by changing the lenses.

The concept of “connected” lenses for which it would be possible to control the color remotely by using a cell phone for example is relatively old, but to date there is no commercial version, because of the difficulties in producing such a lens.

Indeed, the design of such a lens presupposes both the ability to produce it at a cost that is compatible with mass marketing, and the ability to miniaturize the components sufficiently to allow them to be encapsulated in the lens.

The patent U.S. Pat. No. 8,542,325B2 describes contact lenses that change color in response to various stimuli such as changes in body temperature. The change of color relies on the use of liquid crystals.

The application KR 20200020021116U describes also a solution relying on the use of thermochromic components, that make it possible to modify the color as a function of changes of ambient temperature.

In the case of the use of thermochromic compounds, the change of color cannot easily be controlled by the user.

Moreover, contact lenses have been conceptualized on the basis of the change of color of photochromic colorants upon exposure to UV rays from the sun. These colorants make it possible to obtain consultations that are personalized in terms of UV protection. The contact lens can change color when it is exposed to the light of the sun and thus assist the user in perceiving the change of color within his or her visual field.

The patent U.S. Pat. No. 10,678,068B2 describes a contact lens comprising a retina-protecting blocking filter, placed in front of the pupil, that is normally neutral but possibly colored, and the transmission factor of which is variable and electronically controlled. The blocking filter is controlled permanently with a continuous gradation and the electronic circuit comprises a microprocessor, one or more glare sensors such as a photovoltaic cell and a micro-battery. The complexity of the electronic circuit renders the integration thereof in a lens difficult and costly. Additionally, the autonomy remains relatively limited, because of the need for a permanent electrical power supply for the microprocessor.

### Explanation of the Invention

There is consequently a need to benefit from a contact lens that allows a change of color that can easily be controlled by the user, suitable for large-scale production for purely cosmetic use, or for other types of usages, if so desired.

### SUMMARY OF THE INVENTION

The invention aims to meet this need, and it succeeds in doing so, according to a first of its aspects, by proposing a contact lens, notably of scleral type, with user-controllable change of color hue, comprising:
an electro-optical structure comprising at least one layer of a bistable absorbent electro-optical material, that can switch under the effect of the application of an electrical field from at least one first stable state to at least one second stable state having different colorimetric absorption properties, and preferably vice versa under the effect of the application of an electrical field of opposite polarity, this change of state of said material leading to the modification of the visible color of the contact lens, the electro-optical material extending in an annular region intended to at least partially cover the iris while leaving a central zone free,
an electronic circuit encapsulated in the lens, configured to subject said material to an electrical field provoking the change of state thereof, in response to the reception of a corresponding control signal.

A “scleral” type lens is understood here, and in the context of the invention, in the usual sense, namely a contact lens of relatively large diameter which, in configuration worn by the eye, passes bridge-wise over the cornea without touching it, by bearing on the sclera of the eye.

The lens according to the invention, notably when scleral, can be rigid or hybrid (semi-rigid).

The central zone leaves optical access to the pupil, without the light reaching the latter being intercepted by the absorbent electro-optical material, at least for an average pupil diameter. Preferably, this central zone has a diameter of 5 mm, the size of the pupil varying generally from 2 to 8 mm in diameter.

### Electro-Optical Structure

Preferably, the layer of electro-optical material is non-opaque and the electro-optical structure comprises at least one reflecting or semi-reflecting layer, preferably with diffuse reflection, placed behind the layer of electro-optical material, and at least partially, and preferably totally, masking the electronic circuit situated below.

Preferably, the electro-optical structure comprises at least two electrodes disposed on either side of the layer of electro-optical material, notably two transparent or semi-transparent electrodes disposed preferably respectively above and below the layer of electro-optical material.

In some exemplary embodiments, the electro-optical structure comprises at least one first layer of a first bistable electro-optical material and one second layer of a second bistable electro-optical material that is different from the first, which makes it possible to obtain greater color-hue possibilities for the lens, by combination of the colors of the two layers. In this case, the two layers can be controlled simultaneously, or, in a variant, if the electronic circuit is so arranged, selectively independently of one another.

Each layer of bistable electro-optical material is preferably disposed between two electrodes, notably two transparent electrodes, disposed respectively above and below this layer. An electrical insulator material can be present between the different layers so as to avoid short circuits between the electrodes in contact with these layers. The electrodes can be solid or include openings, notably in the central zone of the lens.

### Reflecting or Semi-Reflecting Layer

Preferably, the reflection of the light on the reflecting or semi-reflecting layer mentioned above is of diffuse type, and not specular.

This reflecting or semi-reflecting layer can be colored or not, and its color can be chosen as a function of the hues that are wanted to be given to the electro-optical structure according to the states taken by the absorbent electro-optical material or materials.

The colorimetric properties of the reflecting or semi-reflecting layer can be chosen with respect to those of the layer or layers of electro-optical material such that the contact lens can take at least two distinct visible hues.

The electro-optical structure can comprise a layer of electro-optical material which for example takes a state in which its color is X, and the reflecting or semi-reflecting layer is of color Y, the pairing (X,Y) being chosen for example from among (yellow, cyan), (cyan, yellow), (magenta, cyan) or (yellow, mauve), among other possibilities, such that the lens appears in these conditions with a substantially green, blue or brown hue, respectively. As a variant, the colorimetric properties of the reflecting or semi-reflecting layer are substantially complementary to those of at least one layer of electro-optical material in one of its states, such that the visible hue of the contact lens is then substantially black.

### Electro-Optical Material

“Stable state” and “bistable” material are understood to be an absorbent electro-optical material which retains its colorimetric properties when the electrical field which brought it into this state ceases. These properties can change, if necessary, but at a speed that is sufficiently slow for the user to have the time to benefit from the color obtained for at least 3 hours, even better for at least 12 hours, even better for at least 24 hours.

Preferably, the electro-optical material is of bistable electrochromic, electrophoretic, electroplasmonic or bistable liquid crystal type, notably liquid crystal with colored dichroic dopants.

An electro-optical material for example comprises oxides of metals and transition metals, hexacyanometallate compounds, notably Prussian blue, or even conductive colorants or polymers, viologens, fullerenes or metallopolymers, notably in gel form.

The electro-optical material is preferably of bistable electrochromic type, which offers the advantage of making it easy to obtain a wide variety of hues, through the existence of numerous materials available on the market, and of also having a low control voltage, of the order of 1V.

The change of color can be the result of an oxido-reduction reaction with the material. Since the absorption of the light by the electro-optical material depends on its oxidized or reduced state, it is thus possible to control its colorimetric absorption properties through the application of an electrical field.

The change of hue of the absorbent electro-optical material can be more or less rapid, depending on its nature and the voltage applied.

When the change of hue is relatively slow, the slowness of the change of hue can be exploited to control the final color obtained, by stopping the transformation when the desired hue or appearance is reached.

As mentioned above, within the electro-optical structure, several compounds capable of changing color as a function of the applied field can be combined. These compounds are for example present in different respective layers. For example, the electro-optical structure comprises two superposed electrochromic compounds present in distinct layers, that can for example take complementary colors, and mounted in reverse such that, when one is active (therefore colored), the other is not (therefore colorless), and vice versa. In this case, it is possible to avoid the use of a reflecting or semi-reflecting bottom layer of complementary color.

These compounds can even be mixed in one and the same layer. For example, at least one layer of absorbent electro-optical material comprises a mixture of at least two compounds that change color under the effect of the application of a voltage. The layer contains for example a mixture of at least two different electrochromic compounds, notably taking different colors (for example cyan and magenta) when subjected to an electrical field.

For example, the layer of absorbent electro-optical material comprises a mixture of at least two different electrochromic compounds, the mixture being arranged to exhibit a non-homogeneous color distribution when subjected to an electrical field, notably a distribution creating a pattern roughly approximating a natural iris.

It is notably possible to choose compounds that have different voltage thresholds and/or transformation kinetics, such that it is possible to control the resulting color by choosing the amplitude of the voltage applied and/or the duration of application of the voltage. For example, in the case of a mixture of electrochromic compounds, the selection of the color can be made by modulating the voltage applied. For example, the application of a voltage V1 activates one color, for example red, and the application of a higher voltage V1+ΔV activates another color, for example blue, in addition to the first. In this case, the activation of the compound of higher activation voltage necessarily leads to the activation of the compound of lesser activation voltage, which may not be the case when using two distinct layers each containing an electrochromic compound.

A neutral electrochromic compound (that is to say one that is black or transparent) disposed in front of a colored background (for example green or blue) can also be used, and produce a change of color of the lens, notably of the luminance, when it changes state. It is then possible to act on the duration of application of the electrical field and on the transformation kinetic to gradually modulate the luminance of the color of the lens. For example, a high duration of application of the field leads to a strong darkening of the compound, and therefore a great reduction of the luminance; on the other hand, a shorter duration of activation leads to a lesser darkening, and therefore a lesser reduction of the luminance.

It is even possible to use an ink or a mixture of electrophoretic inks as bistable electro-optical material. Examples of electrophoretic inks are described in the article entitled A Full Color Electrophoretic Display, S.J. Telfer et al, 42-4/S.J. Telfer Invited Paper SID 2016 DIGEST.

### Activation Device

In order to provoke the change of color of the lens, various activation devices can be used. Preferably, the activation device is radiofrequency, which makes it possible to emit a radiofrequency field which can be converted into electrical energy, for example by inductive coupling, in the lens to power the electronic circuit thereof.

The control can be obtained in one example by simple conversion of energy of the activation field into voltage, from an activation electromagnetic field. In this case, the control signal is reduced to the activation electromagnetic field.

The radiofrequency field emitted by the activation device can also make it possible to control the change of color, either because the electronic circuit is configured to provoke a change of color on each new activation by the radiofrequency field, or because the radiofrequency field carries a control signal which is decoded by the electronic circuit of the lens to produce the corresponding change of color.

The activation device can also emit an optical signal, for example IR, which is decoded by the electronic circuit of the lens. That presupposes, in this case, the presence in the lens of an autonomous electrical power source.

The activation device can be a specific device, which is for example offered to the user at the same time as the lenses, for example in one and the same packaging. As a variant, the activation device is a device that has other uses elsewhere, for example a cell phone.

The activation device can comprise an on/off switch in its simplest version, in which each new activation of the electronic circuit of the lens is accompanied by a change of color. As a variant, the activation device comprises a selector that makes it possible to choose at least one resulting hue.

The selection of hue can be binary or more complex, and the activation device can notably act on the duration of activation to gradually modify the hue, as explained above.

As a variant, the application device emits a signal which codes, for example, the luminance and/or the hue, and the electronic circuit of the lens decodes this signal to translate it into voltage levels and/or durations of application of the voltage in the electro-optical structure. The application device can also translate a luminance level and/or a tint that are selected by the user directly into a duration and/or an intensity of activation of the lens, the electronic circuit thereof then being totally passive.

The activation of the lens can be performed before it is fitted, or, as a variant, in situ after that.

When the activation is performed before the lens is fitted, the activation device can comprise a support making it possible to position the lens in a predefined way for the activation, or a sterile packaging containing the lens. When the activation is performed by radiofrequency, such a support makes it possible to control more accurately the intensity of the field induced in the lens, by making it possible to position the lens with a predefined orientation and separation of the coil of the activation device, which is advantageous when the intensity of the activation directly controls the amplitude of the field applied to the bistable optical material.

The activation device can be re-usable, and the lenses can be single use.

### Electronic Circuit

The electronic circuit is preferably arranged to receive an RF or optical, preferably IR, control signal, preferably an RF signal.

The electronic circuit comprises, for example, at least one antenna or another type of sensor, for example optical, making it possible to receive the energy necessary to its operation, preferably at least one antenna comprising one or more turns extending around said central zone.

The electronic circuit is preferably arranged such that the energy necessary to the operation of the electronic circuit is provided by the control signal.

In one embodiment, the electronic circuit comprises two reception circuits tuned to different respective frequencies and/or sensitive to different respective polarizations of the control signal, preferably two reception circuits tuned to different respective frequencies, these reception circuits making it possible to apply respective electrical fields of opposite polarities and/or of different amplitudes to at least one layer of electro-optical material, the lens then preferably not having any electric battery.

Preferably, each reception circuit comprises a specific antenna, preferably an antenna comprising at least one turn, and a respective rectifier by which the reception circuit is linked to the electro-optical structure. In this case, the control can be performed by simple conversion of the received field into a voltage applied to the electro-optical structure.

As a variant, the electronic circuit is arranged to generate sequentially, each time it receives the control signal, a power supply voltage of the electro-optical structure, the polarity of which is opposite to that previously generated, the lens preferably comprising an electric micro-battery to make it possible to store the power supply polarity of the electro-optical structure in the absence of reception of the control signal. The electrical consumption can be very low, which is advantageous for obtaining the autonomy sought.

As mentioned above, it is possible to act on the duration of application of the field and/or on the amplitude of the voltage applied to control the color.

For example, the electronic circuit can be arranged to decode a control signal so as to translate it into a corresponding duration of application of the electrical field to the electro-optical material, when the color obtained is a function of this duration of application. The luminance of the color of the lens can thus for example be controlled.

In another example, in the case of use of a mixture of electrochromic compounds, the control signal is decoded to translate it into an amplitude of application of the voltage to this mixture.

Another subject of the invention is an assembly comprising, on the one hand, a lens according to the invention and, on the other hand, an activation device making it possible to generate the state-changing control signal, notably an activation device comprising a bifrequency emitter tuned to the two frequencies of the antennas of the abovementioned electronic circuit.

Another subject of the invention is a method for provoking the change of color of a contact lens according to the invention, or belonging to an assembly as defined above, the method comprising the step consisting in:
emitting a control signal using an activation device, the reception of this control signal by the electronic circuit of the lens provoking the application to the electro-optical material of an electrical field of a polarity, of an amplitude and/or of a duration that are predefined, causing the optical material to change state, the material retaining this state when the electrical field ceases to be applied.

### BRIEF DESCRIPTION OF THE DRAWINGS

The invention will be able to be better understood on reading the following detailed description of an exemplary nonlimiting implementation thereof, and on studying the attached drawing, in which:

FIG. 1 is a schematic and partial cross-sectional representation of an example of a lens according to the invention,

FIG. 2 represents an example of an electronic circuit of the lens,

FIG. 3 represents an example of a printed circuit of the electronic circuit,

FIG. 4 represents a variant electronic circuit of the lens,

FIG. 5 illustrates the action of different layers of the optical structure on the color of the light reflected,

FIG. 6 schematically and partially represents a variant embodiment of the optical structure with two layers of electro-optical absorbent material.

### DETAILED DESCRIPTION

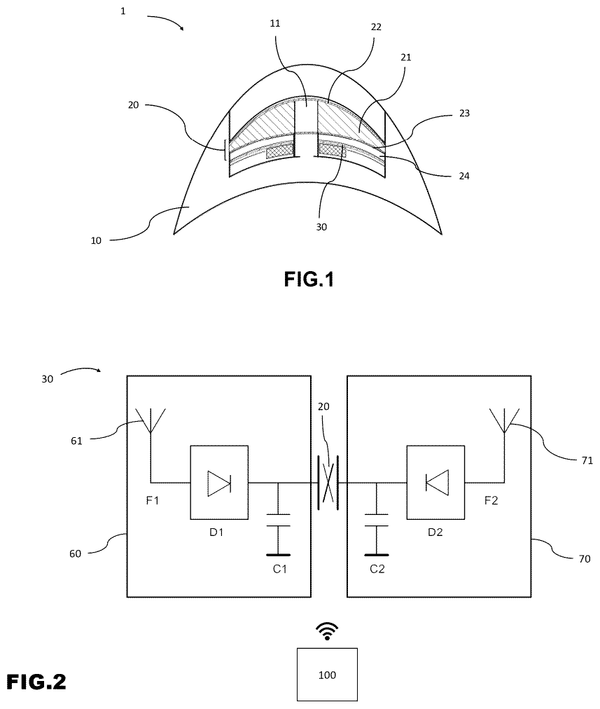

FIG. 1 schematically represents an example of a contact lens 1 according to the invention, comprising a body 10 encapsulating an electro-optical structure 20 and an electronic circuit 30 controlling the electro-optical structure 20.

The lens 1 is for example of scleral type, and can include a refractive correction or not. The lens can be single-use or disposable after a certain number of uses.

The electro-optical structure 20 is intended to cover the iris of the eye on which it is fitted, to modify the visible color thereof, for an esthetic purpose. The change of color of the electro-optical structure 20 results from the change of state of at least one layer 21 of an absorbent electro-optical material thereof.

Preferably, the optical structure 20 has an annular form, and does not cover a central zone 11, extending all around the latter. The change of color of the electro-optical structure 20 does not affect the central zone 11 of the lens, thus leaving the pupil free, at least when the latter is not excessively dilated.

In FIG. 1, the optical structure 20 is represented with a variation of thickness, but it can also have a substantially constant thickness, notably in order not to generate any variation of luminance due to a thickness variation of the electro-optical material.

The electro-optical structure 20 can comprise two electrodes 22 and 23 between which the layer 21 of electro-optical material is disposed. These electrodes 22 and 23 are preferably transparent, and can each entirely cover the layer 21.

These layers can be produced with varied profiles. They can be solid or have openings, notably in the central zone 11 of the lens. They can pass through the central zone 11, as represented in FIG. 1, or not.

The electrodes 22 and 23 are for example produced in an electroconductive polymer such as a mixed oxide of indium and of tin (ITO) or even poly(3,4-ethylenedioxythiophene) (PEDOT).

The electro-optical structure 20 also comprises, in the example considered, a bottom layer 24, the optical properties of which are chosen as a function of those of the layer 21 and of the colors that are sought to be generated, as is detailed later.

The electronic circuit 30 is disposed behind the bottom layer 24, so as to be masked thereby and not visible.

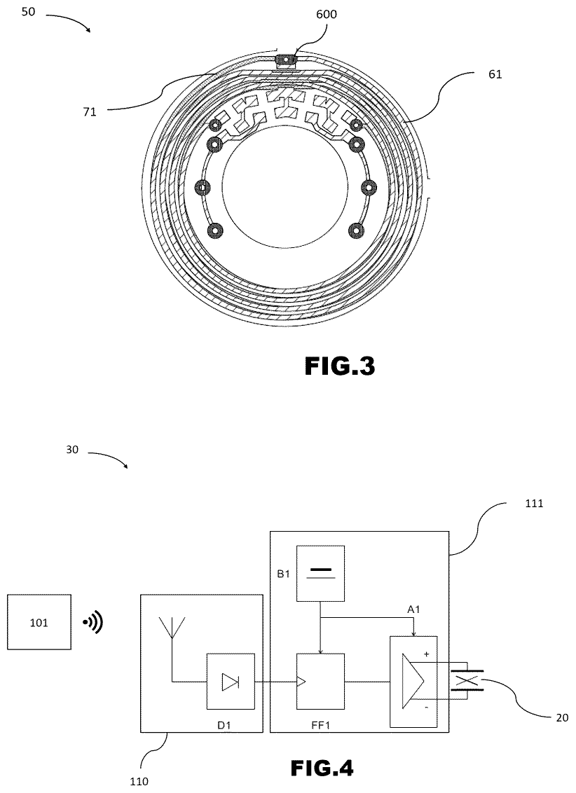

Its components extend around the central zone 11 so as not to block the light reaching the pupil. The electronic circuit can extend over the entire available surface of the iris, as represented in FIG. 3.

The electronic circuit 30 can be produced in various ways, but preferentially with at least one RF reception circuit with magnetic antenna comprising one or more turns produced for example on a printed circuit 50 such as that illustrated in FIG. 3.

In an exemplary embodiment illustrated in FIG. 2, the circuit 30 comprises two reception circuits 60, 70, each tuned to a respective frequency F1 or F2.

These circuits 60, 70 comprise, for example, magnetic antennas 61, 71, the turns of which are produced on opposite respective faces of the printed circuit 50, as illustrated in FIG. 3.

FIG. 3 shows only the printed tracks corresponding to the antennas 61 and 71. The antennas 61 and 71 are for example each linked to a tuning capacitance (not represented), and connected to a common ground 600.

The reception circuits 60 or 70 comprise respective rectifiers composed for example of diodes D1, D2, and filtering capacitors Cl and C2, for example connected between the cathode of the diode and the ground, the anode of each diode being linked to its respective antenna.

Thus, the polarities which are applied to the electrodes 22 and 23 are opposite depending on the reception circuit which is activated.

In order to control the lens 1, it is possible to use a control device 100 capable of emitting, as required, at one of the frequencies F1 and F2, and represented schematically in FIG. 2. This control device 100 for example comprises two emission circuits with magnetic antennas tuned respectively to the frequencies F1 and F2, and at least one control button making it possible to select the emission circuit and trigger the emission. Carrier frequencies are used for example that are of the order of 12.5 MHz for F1, and 6.25 MHZ for F2, corresponding to a submultiple of F1. Thus, when the user selects the frequency F1 and triggers the emission, he or she can, by bringing the device sufficiently close to the lens, activate the reception circuit 60, in such a way that the latter applies a positive voltage between the electrodes 22 and 23. The reception circuit 70 delivers practically no voltage at this moment, the frequencies F1 and F2 being sufficiently far apart.

The application to the layer 21 of electro-optical material of the electrical field linked to the polarity of the electrodes 22 and 23 causes the latter to take a predefined state.

Once the emission of the activation field of the reception circuit 60 ceases, the electro-optical material retains its state by virtue of its bistability.

To change this state, the user activates the reception circuit 70 by emitting at the frequency F2. In this case, the polarity applied to the electrodes 22 and 23 becomes negative, the reception circuit 60 delivering practically no signal because of the distance between the frequencies F1 and F2.

The application of a field of opposite polarity to the electro-optical material causes the latter to change state. Once the emission ceases, the material retains its state by virtue of its bistability.

In one of the states, the electro-optical material is for example substantially colorless and transparent, and in the other state, colored.

This exemplary embodiment offers the advantage of allowing an extremely simple control of the state of the electro-optical material, with a reduced number of components, which renders the lens compatible with mass production at a relatively low cost.

The control device 100 is for example incorporated in a key-holder which can be brought closer to the lens by the user.

Obviously, the electronic circuit 30 can be produced otherwise without departing from the framework of the present invention, and for example with a function for memorizing the polarity applied to the electro-optical material and/or by allowing the application of several voltage levels for at least one of the polarities.

The electronic circuit 30 can comprise a micro-battery B1, as illustrated in FIG. 4, making it possible to use one or more logic circuits and/or a microprocessor or other dedicated circuit.

The micro-battery can be a deformable battery, encapsulated in the lens. It can notably be a battery as described in the application WO 2018/167393 A1. Such a battery has the advantage of having very small dimensions, typically a surface area of the order of 0.75 cm². Other advantageous characteristics of this flexible battery are that it is stretchable and self-repairable so as to be best incorporated in the contact lens.

In the example of FIG. 4, the electronic circuit 30 includes only a single reception circuit 110, tuned to a frequency FF1, and the signal of which is for example rectified using a diode D1. The frequency used is for example of the order of that of the high frequencies used for the RFID systems, for example 12.5 MHz.

A control circuit 111 is provided to, on the one hand, ensure the charge of the micro-battery B1 when the reception circuit is activated, and, on the other hand, transform the activation of the reception circuit into a control signal controlling the polarity applied to the electro-optical material.

For example, the control circuit 111 is produced such that any new activation thereof provokes a change of state of the polarity applied, with respect to that previously applied.

When the activation of the reception circuit 110 ceases, the control circuit 111 ceases to apply an electrical field to the electro-optical material, and the latter retains the state in which it is left.

Nevertheless, the micro-battery B1 allows the control circuit 111 to retain in memory the state of the polarity applied. Thus, when the reception circuit is newly activated, the control circuit 111 can determine the new polarity to be applied, knowing the old one. The control circuit 111 can be produced simply with a logic flip-flop, the state of which is retained by virtue of the power supply being maintained by the micro-battery B1.

As represented in FIG. 4, to activate the reception circuit 110, it is possible to use an activation device 101 comprising an emitter tuned to the frequency FF1 of the antenna of the electronic circuit 30. This device is for example produced specifically.

In the case of use of a more complex electronic circuit 30, capable of decoding transmitted information, it is possible to use an activation device having another use, such as a smartphone or a connected watch.

Different colors can be generated for the lens 1 in different ways.

When the electro-optical structure comprises a bottom layer 24, as in the example illustrated in FIG. 1, the optical properties of this layer 24 are advantageously chosen as a function of the colors that are wanted to be generated, and of the colorimetric absorption properties of the layer 21 of electro-optical material placed in front.

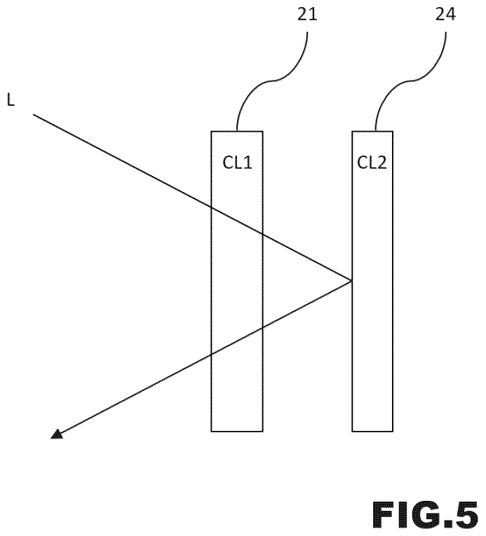

Since the bottom layer 24 is preferably reflecting or semi-reflecting with diffuse reflection, it can at least partially reflect the light L which has not been absorbed by the layer 21, as illustrated in FIG. 5.

It is then possible to choose the color of the layer 24 so as to reflect only the light of the desired color.

A cyan color CL2 is for example chosen as color of the layer 24, so as to absorb the red incident light. Thus, if the electro-optical material 21 takes a red color state CL1, a lens of black color C3 will be obtained by subtractive synthesis, because, since the two layers 21 and 24 have complementary colorimetric properties, substantially all the incident light will have been absorbed by the electro-optical structure.

Similarly, if the layer 21 takes a yellow color state CL1 or a magenta color state CL1, a lens of substantially green color or of substantially blue color, respectively will be obtained.

Any combination of colors (CL1, CL2) between the layers 21 and 24 is possible, in order to generate natural hues CL3, or not, depending on what is required. Some of these combinations, among others, are listed in the table 1 below, in a nonlimiting manner.

In the table 1 hereinbelow, CL1 is the color of the layer 21 of electro-optical material, CL2 is the color of the bottom layer 24, CL3 is the visible resulting color obtained for the lens 1. It is considered here that the incident light L is of white color.

TABLE 1

| CL1 | CL2 | CL3 |
|---|---|---|
| Red | Cyan | Black |
| Yellow | Cyan | Green |
| Magenta | Cyan | Blue |
| Cyan | Yellow | Green |
| Cyan | Red | Black (or brown if the red tends toward orange) |
| Cyan | Magenta | Blue |
| Cyan | Mauve | Blue (substantially darker) |
| Yellow | Blue | Black |
| Yellow | Mauve | Brown |
| Magenta | Green | Black |

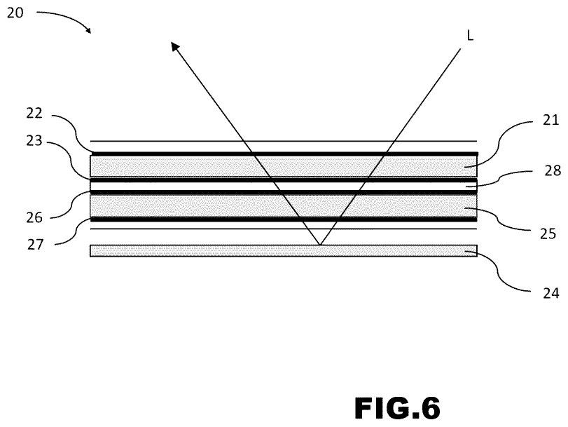

In a variant, the electro-optical structure comprises a second layer 25 of electro-optical material, notably of electrochromic type, disposed behind the first layer 21 of electro-optical material and in front of a bottom layer 24, as illustrated in FIG. 6.

Electrodes 26 and 27 can be disposed on either side of the second layer 25, the state of which can then be changed independently of that of the first layer 21, by application of an electrical field between the electrodes 26 and 27.

An insulating material 28 is present between the two layers of electro-optical material 21 and 25.

Depending on their state, the absorbent layers 21 and 25 absorb the light of a certain color. Their colorimetric properties are chosen so as to be able to obtain several possible resulting colors for the lens 1, for example corresponding to realistic iris hues.

In this variant, the bottom layer 24 can be hued or not, depending on the combinations of color that are wanted to be produced.

It is also possible to act on the kinetics of the oxido-reduction reactions leading to the changes of color in the layer or layers of absorbent electro-optical material to widen the panel of visible colors that can be obtained for the lens 1.

It is then possible to use the activation device 101 to control the duration of application of the electrical field, which makes it possible to vary the density of absorbents in the layer or layers of electrochromic material concerned, and adjust the color or the absorption thereof.

In other exemplary embodiments, at least one layer of electro-optical material comprises several mixed electrochromic compounds. Thus, by modulating the voltage applied to this layer, it is possible to select, by addition of activated colors, different colors in one and the same layer. An applied voltage V makes it possible for example to change the layer into a state that absorbs the blue color, and by increasing the applied voltage to V+ΔV, a state that absorbs both the blue and red colors is activated.

The mixture of electrochromic compounds and/or the different layers can notably make it possible to create a non-homogeneous color distribution when subjected to a certain voltage level, for example a distribution forming a pattern which would reproduce the variations of color of a natural iris.

The different voltage levels can be obtained in several ways.

It is for example possible to move the control device more or less close to the lens 1 to vary the voltage level induced in the lens and therefore the amplitude of the electrical field applied.

In a variant, the electronic circuit 30 comprises several reception circuits each being able to apply a voltage level, which is useful notably when the electro-optical material comprises a mixture of electrochromic compounds having different activation voltages. These circuits are for example tuned to respective frequencies F1, F2. The circuit of frequency F1 generates a voltage V when activated, and the circuit of frequency F2 generates a higher voltage V′, of the same polarity. A third circuit of frequency F3 makes it possible to apply a voltage of opposite polarity, which makes it possible to reset the electro-optical material. The user can apply a voltage V or V′ by selecting the activation frequency, and therefore the resulting color. To change color, the user can apply the voltage V′ by activating with the frequency F2 if the voltage previously applied was V, or apply a voltage of reverse polarity by activating with the frequency F3 then the voltage V by activating with the frequency F1. To generate different voltages as a function of the frequency, it is possible to act for example on the quality factor of the reception circuit.

In another variant, the electronic circuit 30 comprises the embedded intelligence needed to process control signals coding an instruction for the lens, for example the change of polarity of the applied field and/or its amplitude.

To produce the encapsulation of the electro-optical structure and of the electronic circuit, it is possible to proceed in any suitable manner.

For example, to produce the body of the lens, a set of two encapsulation elements joined together is used, the first material of which is normally implemented for manufacturing rigid contact lenses. It can for example concern materials having at least a polymer base.

This set of encapsulation elements comprises, for example, a hollow bottom encapsulation element, the profile of which is defined according to the nature and the design of the component or components to be encapsulated, and a male top encapsulation element, the profile of which is matched to that of the hollow element and of the component or components to be encapsulated. The encapsulation is done for example via a method for polymerizing a so-called bond material. In the encapsulation, a diopter can possibly be formed in the central zone 11 of the lens.

After the machining thereof, the encapsulation elements can undergo an additional step in order to prepare them to be subjected to specific constraints, linked to the method of assembly and/or to the nature of the encapsulated component or components. That for example necessitates non-uniform volumes with positioning and/or alignment studs, possibly peripheral drains/grooves to evacuate the air and/or the excess of bonding polymer material during a phase of compression of the two elements.

To obtain the assembly of the two elements with the desired encapsulation of the electronic circuit and of the electro-optical structure, a compression force can be applied between them. The hollow bottom element can be placed in a bottom insert of a compression device, and the male top element can be placed in a top insert. A few drops of bonding polymer can be deposited on the periphery of the hollow element. This polymer is for example acrylate based. The frame of the device then applies a compression force to allow the bonding for a time determined as a function of the materials used for the elements and for the bonding material.

Obviously, the invention is not limited to the examples described.

The electronic circuit can be more complex and the latter can comprise, for example, one or more reconfigurable control circuits, of SWIPT (acronym for “Simultaneous Wireless Information and Power Transfer” type, for example by an external instruction received by the RF antenna of the contact lens.

The contact lens can comprise means for harvesting and converting mechanical, light or chemical energy originating from the tears of the eye, to electrically power the electronic circuit.

The lens can be produced other than by the method which has just been described. For example, the encapsulation of the different elements in the contact lens can be done by any suitable method, notably by molding.

1. A contact lens, notably of scleral type, with user-controllable change of color hue, comprising:
an electro-optical structure comprising at least one layer of a bistable absorbent electro-optical material, that can switch under the effect of the application of an electrical field from at least one first stable state to at least one second stable state having different colorimetric absorption properties, this change of state of said material leading to the modification of the visible color of the contact lens, the electro-optical material extending in an annular region intended to at least partially cover the iris while leaving a central zone free,
an electronic circuit encapsulated in the lens, configured to subject said material to an electrical field provoking the change of state thereof, in response to the reception of a corresponding control signal.

2. The lens as claimed in claim 1, the layer of electro-optical material being non-opaque and the electro-optical structure comprising at least one reflecting or semi-reflecting layer with diffuse reflection, placed behind the layer of electro-optical material, and at least partially, and preferably totally; masking the electronic circuit situated below.

3. The lens as claimed claim 1, the electro-optical structure comprising at least two electrodes disposed on either side of the layer of electro-optical material, notably two transparent electrodes disposed respectively above and below the layer of electro-optical material.

4. The lens as claimed in claim 1, the electro-optical structure comprising at least one first layer of a first bistable electro-optical material and a second layer of a second bistable electro-optical material that is different from the first.

5. The lens as claimed in claim 1, at least one layer of absorbent electro-optical material comprising a mixture of at least two compounds that change color under the effect of the application of a voltage, notably taking different colors when subjected to an electrical field.

6. The lens as claimed in claim 5, the at least two compounds having different voltage thresholds and/or transformation kinetics, such that it is possible to control the resulting color by choosing the amplitude of the voltage applied and/or the duration of application of the voltage.

7. The lens as claimed in claim 2, the colorimetric properties of the reflecting or semi-reflecting layer being chosen with respect to those of at least one layer of electro-optical material such that the contact lens can take at least two distinct visible colors.

8. The lens as claimed in claim 1, the electronic circuit being arranged to receive an RF or optical, control signal.

9. The lens as claimed in claim 1, the electronic circuit comprising at least one antenna or another type of sensor.

10. The lens as claimed in claim 1, the electronic circuit being arranged such that the energy necessary to the operation of the electronic circuit is provided by the control signal.

11. The lens as claimed in claim 1, the electronic circuit comprising two reception circuits tuned to different respective frequencies and/or sensitive to different respective polarizations of the control signal, these reception circuits making it possible to apply respective electrical fields of opposite polarities and/or of different amplitudes to at least one layer of electro-optical material.

12. The lens as claimed in claim 1, each reception circuit comprising a specific antenna, and a respective rectifier by which the reception circuit is linked to the electro-optical structure.

13. The lens as claimed in claim 1, the electronic circuit being arranged to generate sequentially, each time it receives the control signal, a power supply voltage of the electro-optical structure of which the polarity is opposite to that previously generated.

14. The lens as claimed in claim 1, the electro-optical material or materials being of bistable electrochromic, electrophoretic, electroplasmonic or bistable liquid crystal type, notably liquid crystal with colored dichroic dopants.

15. An assembly comprising, on the one hand, a lens as claimed in claim 1 and, on the other hand, an activation device making it possible to generate the state-changing control signal.

16. A method for provoking the change of color of a contact lens as defined in claim 1 comprising the step consisting in:
emitting a control signal using an activation device, the reception of this control signal by the electronic circuit of the lens provoking the application to the electro-optical material of an electrical field of a polarity, of an amplitude and/or of a duration that are predefined, causing the optical material to change state, the material maintaining this state when the electrical field ceases to be applied.

17. The lens as claimed in claim 1, that can switch under the effect of the application of an electrical field of opposite polarity back from the second stable stage to the first stable stage.

18. The lens as claimed in claim 2, the reflecting or semi-reflecting layer with diffuse reflection masking totally the electronic circuit.

19. The lens as claimed in claim 5, the layer of absorbent electro-optical material comprising a mixture of at least two different eletrochromic compounds.

20. The lens as claimed in claim 8, the electronic circuit being arranged to receive an IR control signal.

21. The lens as claimed in claim 8, the electronic circuit being arranged to receive an RF control signal.

22. The lens as claimed in claim 9, the electronic circuit comprising an optical sensor that makes it possible to receive the energy to its operation.

23. The lens as claimed in claim 9, the electronic circuit comprising one antenna comprising one or more turns extending around the central zone.

24. The lens as claimed in claim 11, the electronic circuit comprising two reception circuits tuned to different respective frequencies.

25. The lens as claimed in claim 12, each reception circuit comprising an antenna comprising at least one turn.

26. The lens as claimed in claim 13, the lens preferably comprising an electric micro battery to allow the storage of power supply polarity of the electro optical structure in the absence of reception of the control signal.

27. The lens as claimed in claim 14, the electro optical material or materials being preferably of bistable electrochromic, type.

28. The assembly as claimed in claim 15, the activation device comprising a bifrequency emitter turned to the two frequencies of the antennas of the electronic circuit of claim 11.

29. A method for provoking the change of color of a contact lens belonging to an assembly as defined in claim 22 comprising the step consisting in:
emitting a control signal using an activation device, the reception of this control signal by the electronic circuit of the lens provoking the application to the electro-optical material of an electrical field of a polarity, of an amplitude and/or of a duration that are predefined, causing the optical material to change state, the material maintaining this state when the electrical field ceases to be applied.
